(19) United States
(12) Patent Application Publication
(10) Pub. No.: US 2024/0303756 A1
(43) Pub. Date: Sep. 12, 2024

(54) SYSTEM FOR HOTEL MAINTENANCE AND OPERATIONS

(71) Applicant: Eoin Heavey, New York, NY (US)

(72) Inventor: Eoin Heavey, New York, NY (US)

(21) Appl. No.: 18/600,757

(22) Filed: Mar. 10, 2024

Related U.S. Application Data
(60) Provisional application No. 63/451,157, filed on Mar. 9, 2023.

(51) Int. Cl. G06Q 50/12; G06Q 10/0631

(52) U.S. Cl. CPC G06Q 50/12; G06Q 10/063114

(57) ABSTRACT

A system for managing hotel operations has a computing system, a user device, a GUI, and a datastore. The user device can be an attendant device or a manager device, and the user role can be an attendant or a manager. The datastore stores data related to a hotel, its rooms, its guests, its staff, its tasks, and its morning meeting. The GUI displays the morning meeting message from the manager device to the attendant device, and shows an attendant checklist panel with a list of rooms and a control to start and stop cleaning. The GUI changes the room status and receives the cleaning time, image, and note from the attendant device. Each room has information comprising id, number, status, type, cleaning indicator, and cleaning result, which comprises the user id, cleaning time, image, and note.

### CROSS-REFERENCE TO RELATED APPLICATIONS

This application claims the benefit of U.S. Provisional Patent Application 63/451,157, filed Mar. 9, 2023, which is hereby incorporated by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Various hotel management systems attempt to change the way in which people work in hotels. Currently in hotel management communication is often through radio, texting, and verbal communication, room allocation is often manual using a clipboard, and managers inspect rooms by visiting floors and rooms, and manually recording the result.

The present invention provides hotels with an easy to use system to manage, oversee and communicate with all areas of a hotel's operation. Embodiments of the invention provide real time communication and room status updates (e.g., Vacant Clean, Vacant Dirty, Do Not Disturb, Refused Service etc.), room allocation, room boards on management user devices and attendant user devices that can be updated in real time. Guests can have a preferred time for their room to be serviced during their stay. Lost and found items can be tracked and logged, mini bar items can be tracked and logged in a streamlined manner. Delivery Services such as laundry and flower deliveries can be tracked. From a manager's perspective, embodiment provide for streamlined inspection via Room Attendant user device, Real time Status updates for maintenance, linen and F&B services, and other hotel management operations.

### BRIEF SUMMARY OF THE INVENTION

The present invention is directed to a system for managing hotel maintenance and operations providing an efficient and streamlined technology to manage hotel operations in real time. Embodiments of the present invention allow all service lines for the back end of hotels to communicate and be more efficient resulting in higher efficiency and less strain on hotel management while having a safer environment for hotel employees. Hotels can use embodiments of the present invention to connect all aspects of their property from housekeeping room auto allocation tools to tailor room attendants board allocations, to tracking room cleaning throughout the day, to overseeing projects, daily tasks and ad hoc requests for housemen and engineers. Embodiments of the present invention also provide communication tools with the multiple delivery services that delivery and pick up from the property on a regular basis-linen/laundry service for example.

Embodiments of the present invention provide integrated solutions to maximize operational efficiency. For example, a hotel manager may hold a digital morning meeting to provide daily reminders and focused team tasks. Embodiments may enable viewing of room specifications, adding specific notes for rooms (VIP, specific guest requests for staff to see), and live tracking of room status as well as ability to adjust room boards in real time (e.g. DND, i.e., Do Not Disturb, updates in real time). Further, an Auto Room Allocation algorithm can be configured to enable a manger to allocate hotel tasks (cleaning, repairs, etc.) according to a unique request or circumstances of a hotel (e.g., certain staff on certain floors, by check in time of rooms, availability of staff during certain shifts, balancing workload, etc.) The allocation algorithm also may allow the order of which rooms need to be cleaned to be updated in real time leading to rooms becoming ready for guests quicker and utilizing staff time more efficiently. The present invention can also be configured to coordinate with delivery services such as linen, laundry, and other services.

Embodiments of the present invention may be configured to track both operational metrics and outcomes. Insight of daily housekeeping quota or workload provides data to support strengths and weaknesses of the department. Tracking and Analytical insight through real time room cleaning times (MinPOR) to aid in control and reduction of CPOR. Retrieve historical data of every room for audit purposes.

Other benefits may include identification and rewarding of high performing staff, real time cleaning minutes per room, data driven results based on room status, check in/out times, enhancement of data for management reporting, and others.

An embodiment of the present invention may be a system for managing operations at a hotel property for a plurality of rooms. The system may comprise a computing system, a user device, a graphical user interface (GUI), and a datastore storing data about the hotel property. The data comprises a hotel associated with a hotel floor and with a plurality of rooms, a workshift associated with a user, a guest, and a tasks dataset. The hotel may comprise a floors-count of the floors in the hotel property. The floor comprises a floor id and a floor-rooms-count of the rooms on the floor. The floor is associated with a plurality of floor rooms each comprising floor room information about a room on the floor. Each of the plurality of rooms comprises hotel room information, and the room information comprises a room id, a room number, a room status, room cleaning information, and a room type. The room cleaning information comprises a cleaning indicator, and a cleaning-result. The cleaning result comprises a user id, and one or more of a cleaning time, an image, and a cleaning note. The room status information may be a dirty status, a clean status, and an out-of-order status, among others. The room may be associated with a room history, and a room note.

The guest comprises information about a visitor to the hotel property. The user comprises a user id and user information containing a user role. The user role may be an attendant or a manger. The user device may be an attendant device (usually a mobile device) and a manager device. The tasks dataset comprises a project, a task, a request, an item, and a task location. The task location may be a hotel, a floor, a room, a common area, a department, and combinations thereof.

The hotel is associated with a morning meeting comprising a meeting-message and a meeting date. The GUI is configured to receive the meeting message from the manager device and display the meeting message on the attendant device, and to display on the attendant device an attendant checklist panel a list comprising an attendant assigned room from the plurality of rooms, and an attendant control associated with the attendant assigned room. The attendant assigned room has a dirty status.

Responsive to activating the attendant control, the GUI is configured to initiate a room cleaning timer counting the cleaning time, and to display on the attendant device a room cleaning view comprising a stop cleaning control. Responsive to activating the stop cleaning control, the GUI receives the cleaning time from the room cleaning timer and is configured to receive one or more of the cleaning image, the cleaning note, and a cleaning finished indicator. In response to receiving the cleaning finished indicator, the GUI is configured to change the room status to the clean status.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 illustrates an embodiment of the present invention.

FIG. 2 illustrates an embodiment of the present invention.

FIG. 3 illustrates an embodiment of the present invention.

FIG. 4 illustrates an embodiment of the present invention.

FIG. 5 illustrates an embodiment of the present invention.

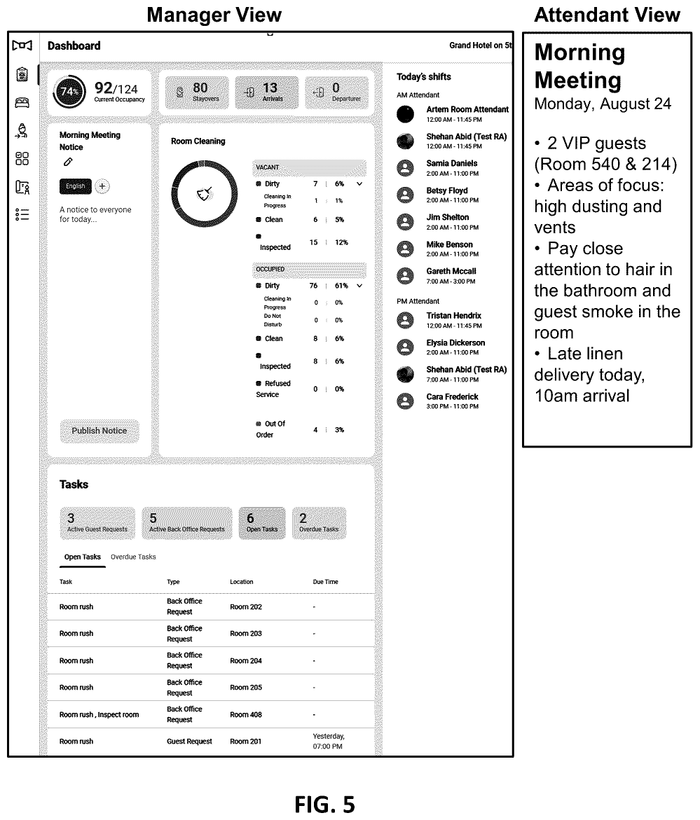

FIG. 6 illustrates an embodiment of the present invention.

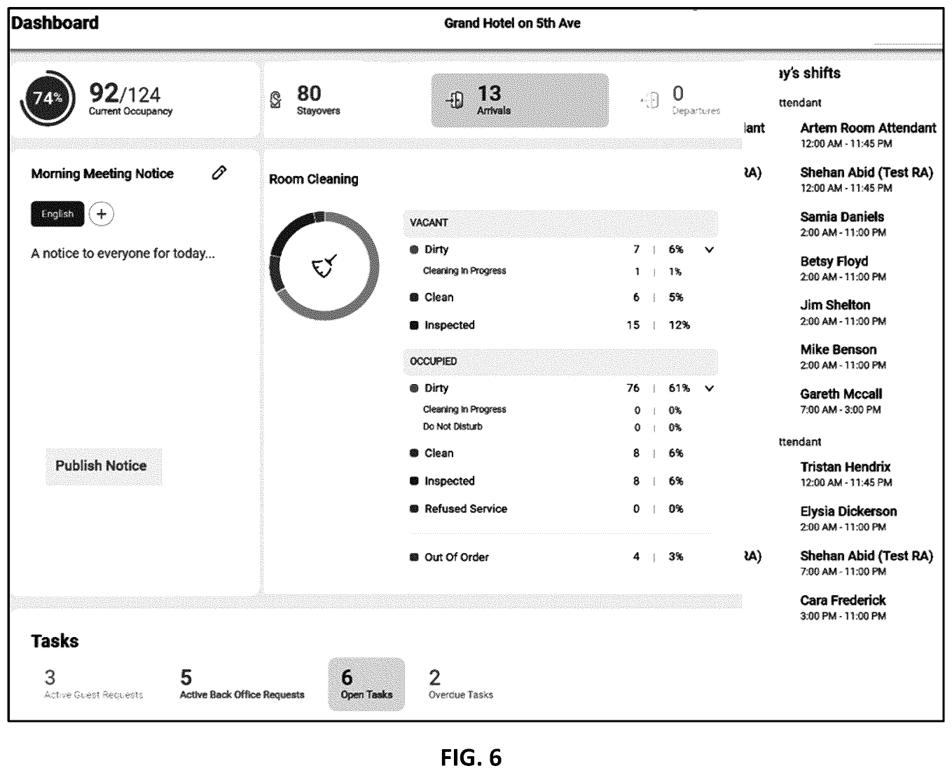

FIG. 7 illustrates an embodiment of the present invention.

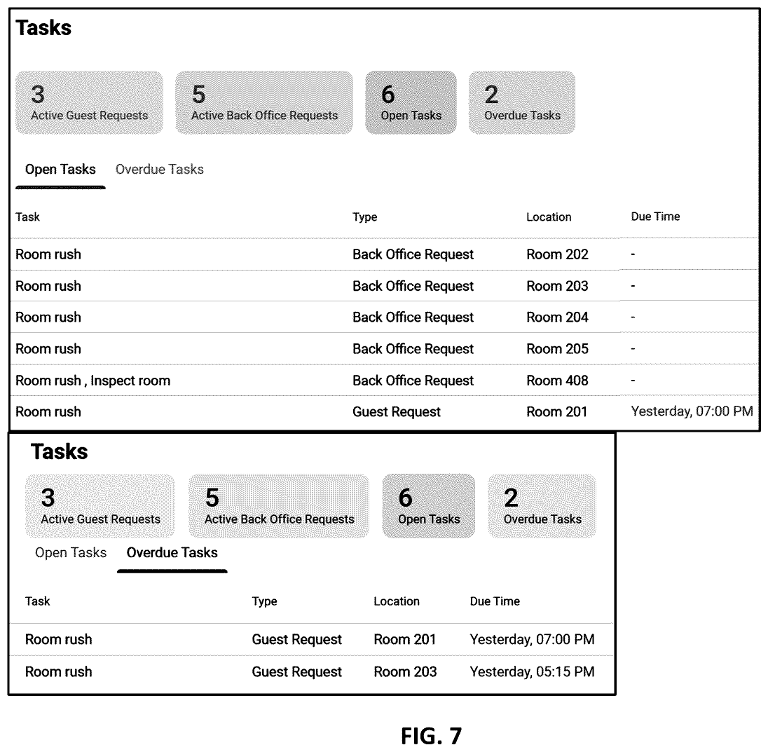

FIG. 8 illustrates an embodiment of the present invention.

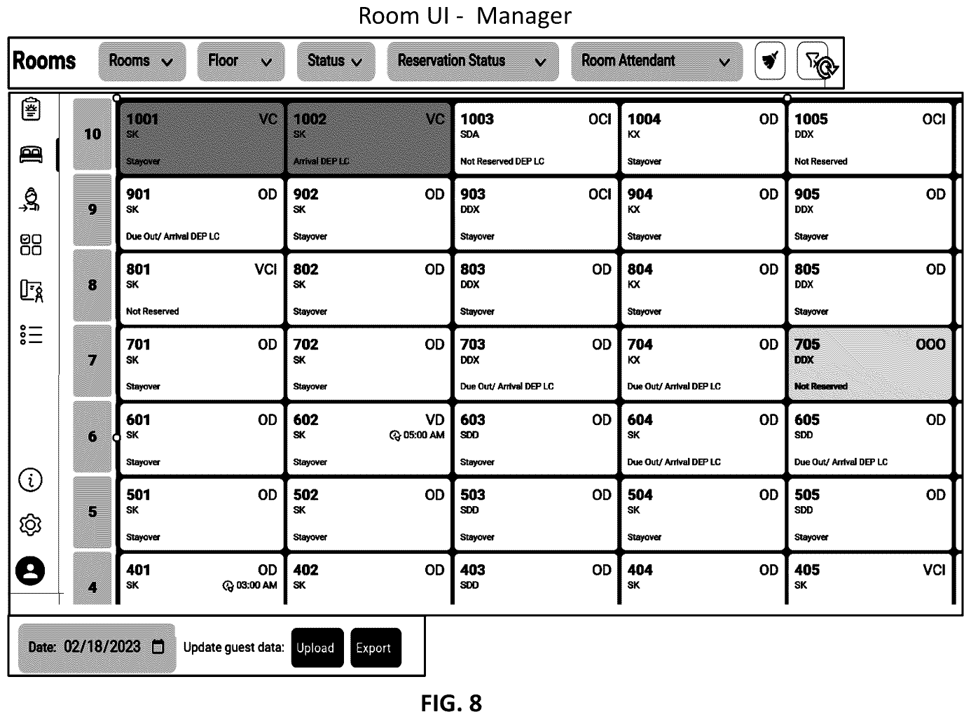

FIG. 9 illustrates an embodiment of the present invention.

FIG. 9A illustrates an embodiment of the present invention.

FIG. 10 illustrates an embodiment of the present invention.

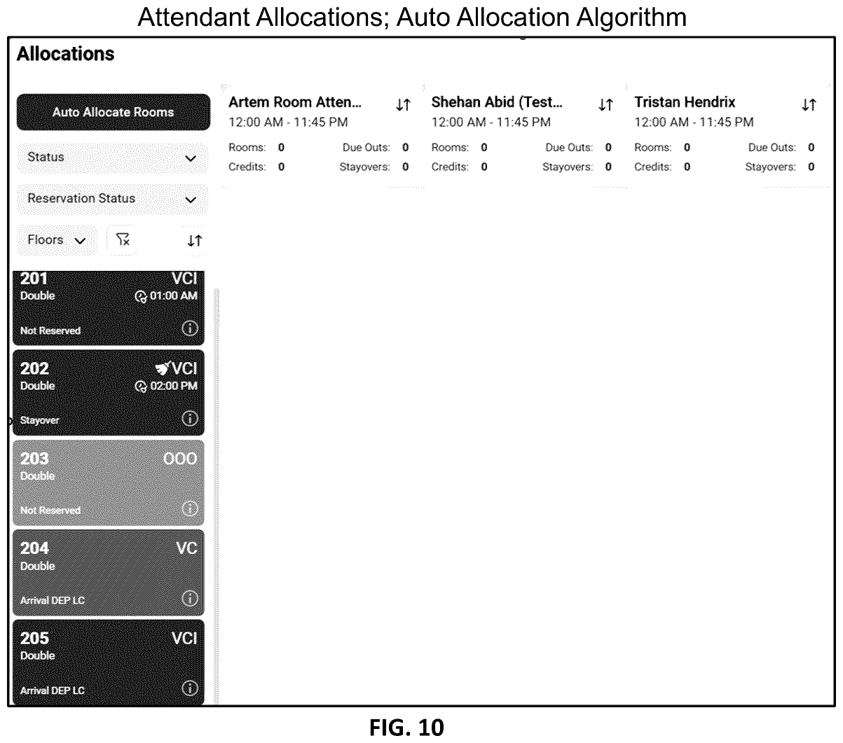

FIG. 11 illustrates an embodiment of the present invention.

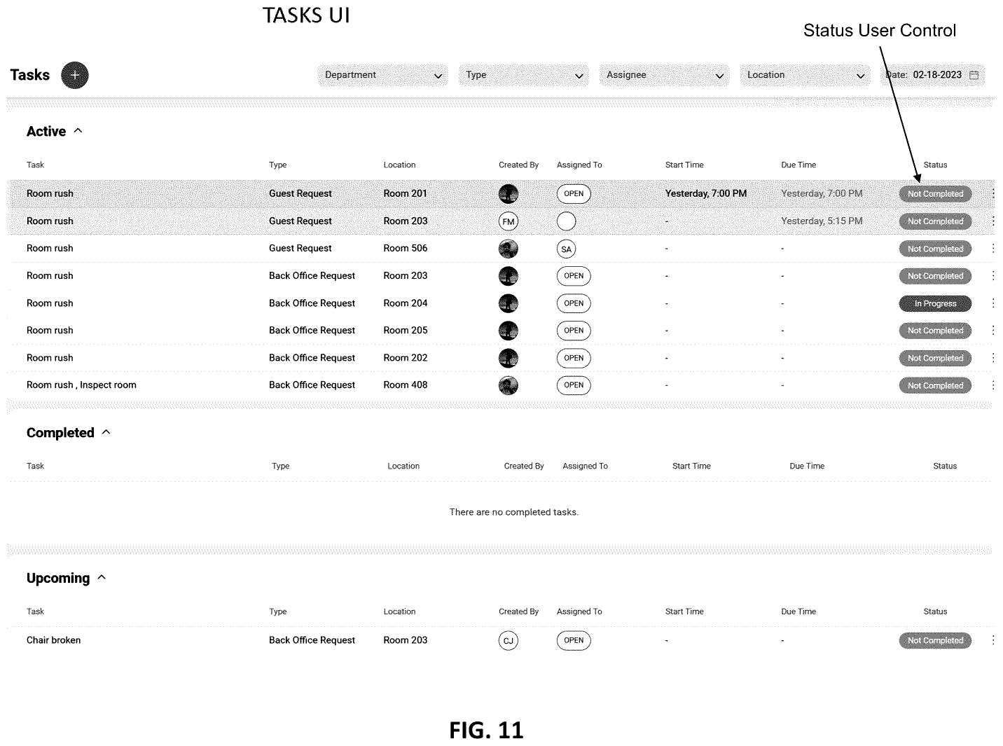

FIG. 12 illustrates an embodiment of the present invention.

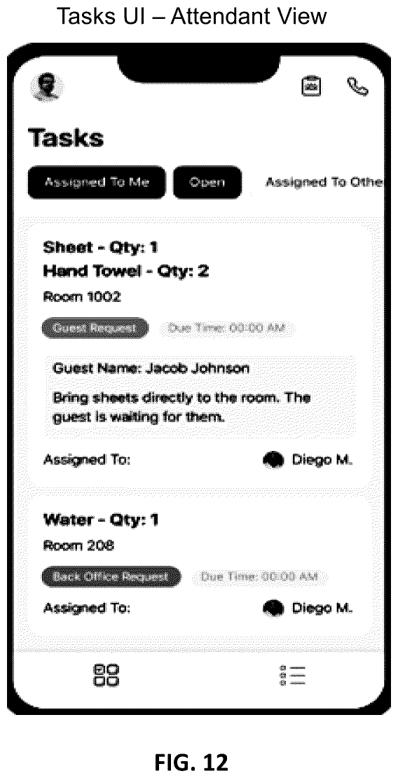

FIG. 13 illustrates an embodiment of the present invention.

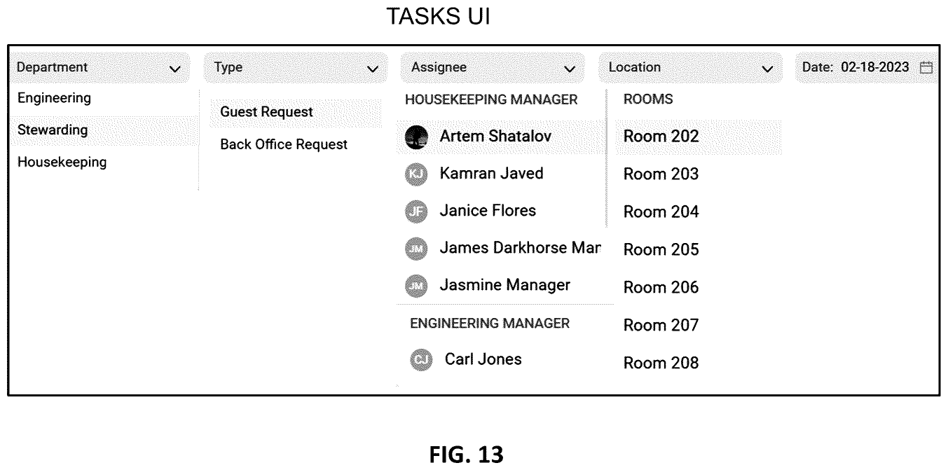

FIG. 14 illustrates an embodiment of the present invention.

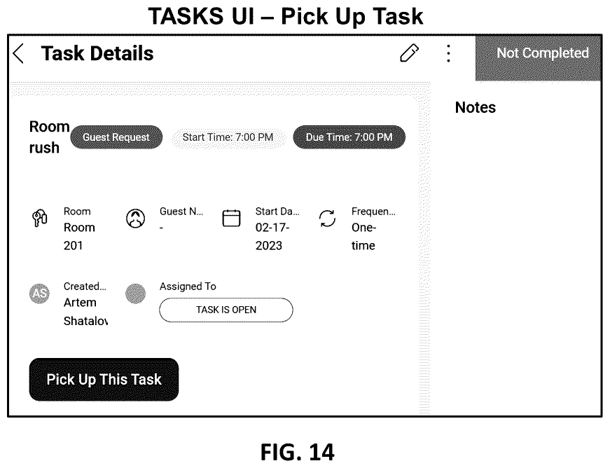

FIG. 15 illustrates an embodiment of the present invention.

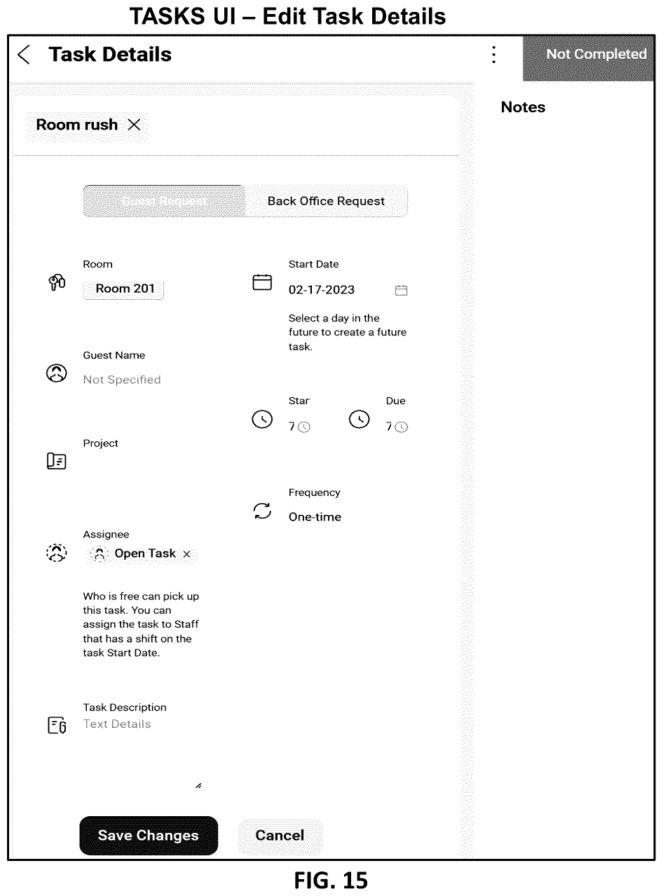

FIG. 16 illustrates an embodiment of the present invention.

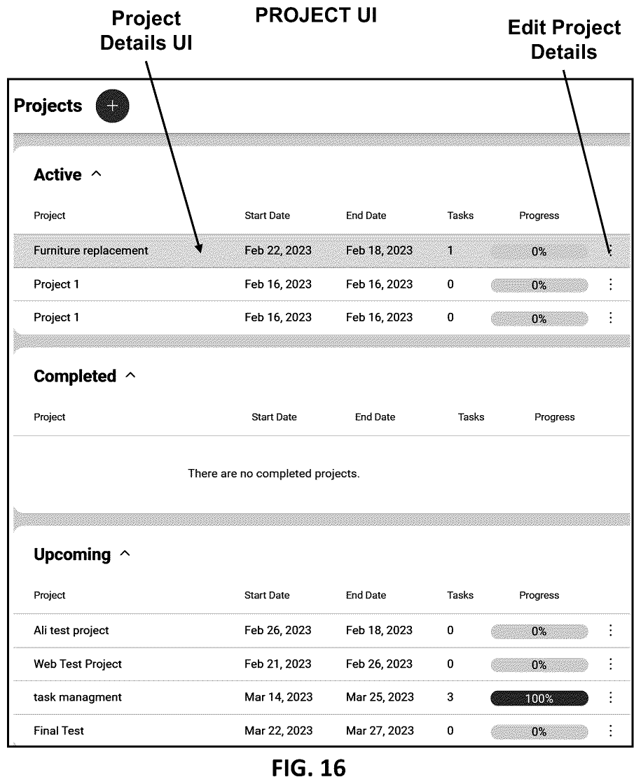

FIG. 17 illustrates an embodiment of the present invention.

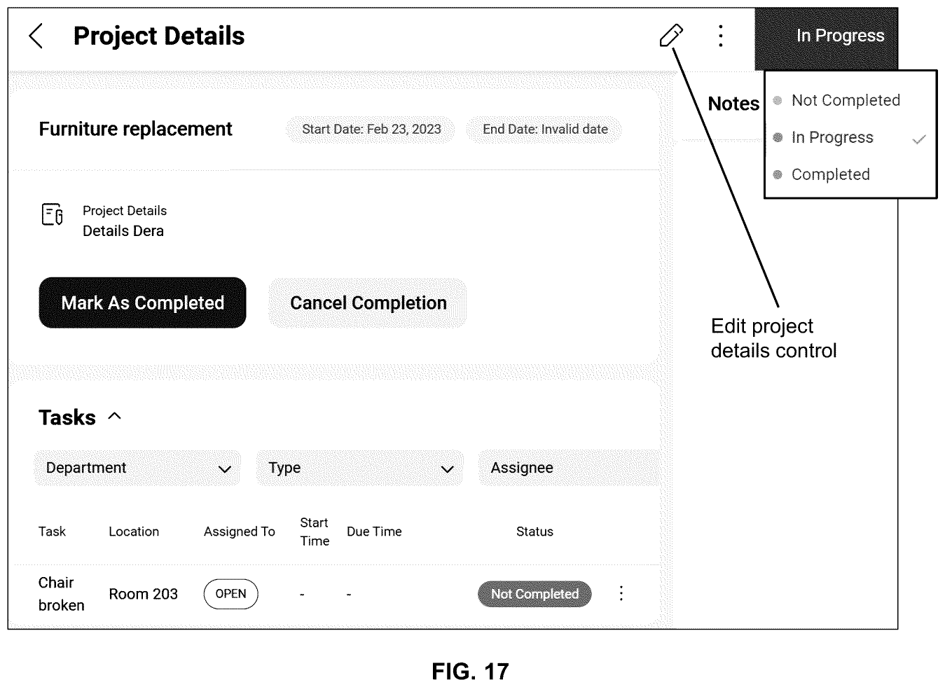

FIG. 18 illustrates an embodiment of the present invention.

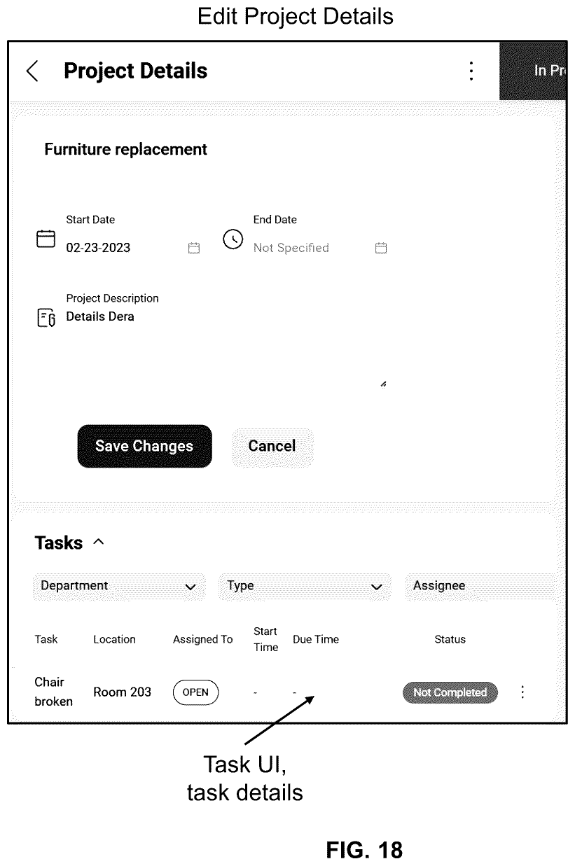

FIG. 19 illustrates an embodiment of the present invention.

FIG. 19A illustrates an embodiment of the present invention.

FIG. 20 illustrates an embodiment of the present invention.

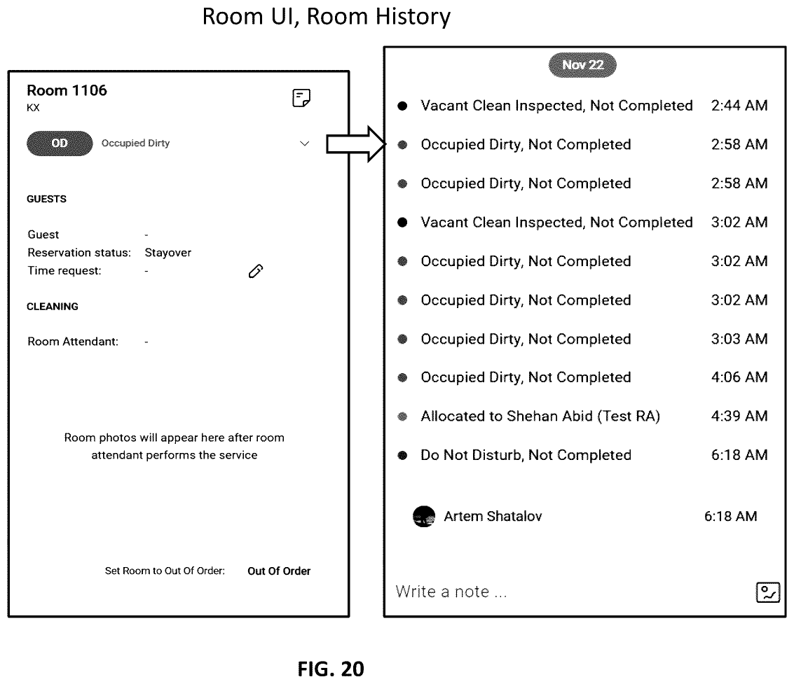

FIG. 21 illustrates an embodiment of the present invention.

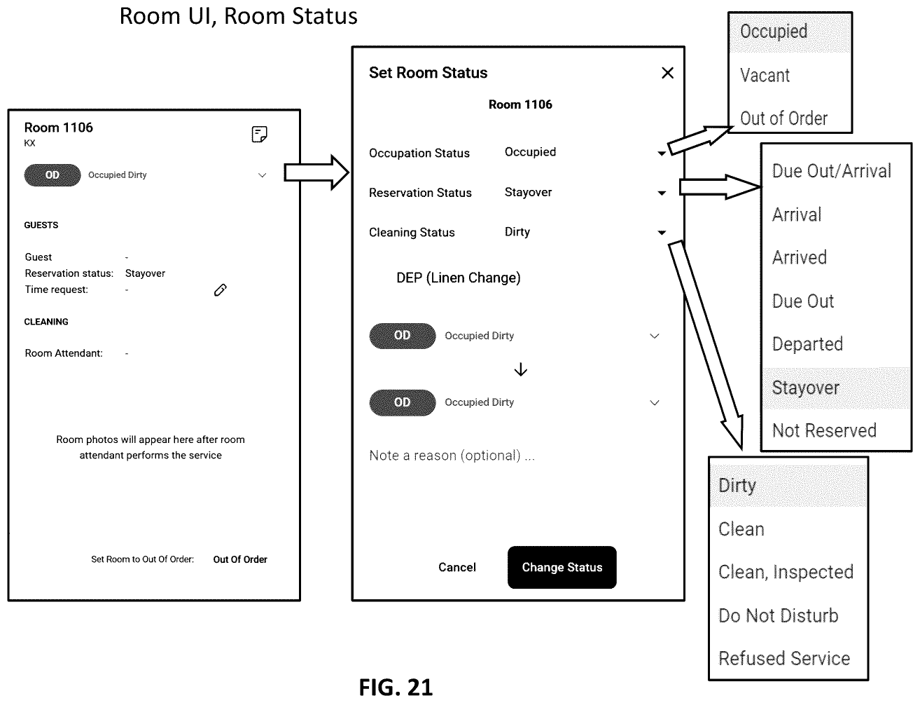

FIG. 22 illustrates an embodiment of the present invention.

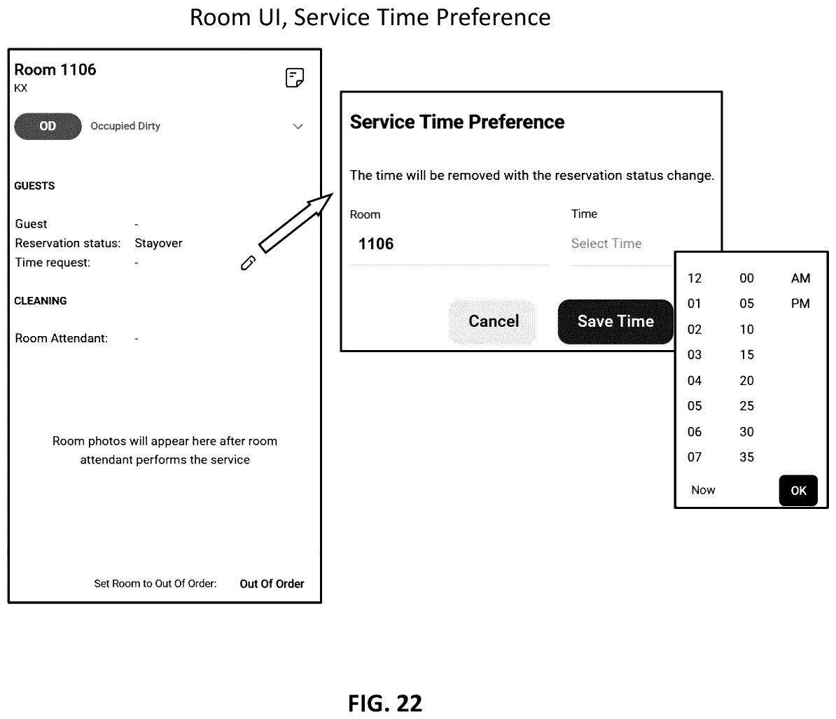

FIG. 23 illustrates an embodiment of the present invention.

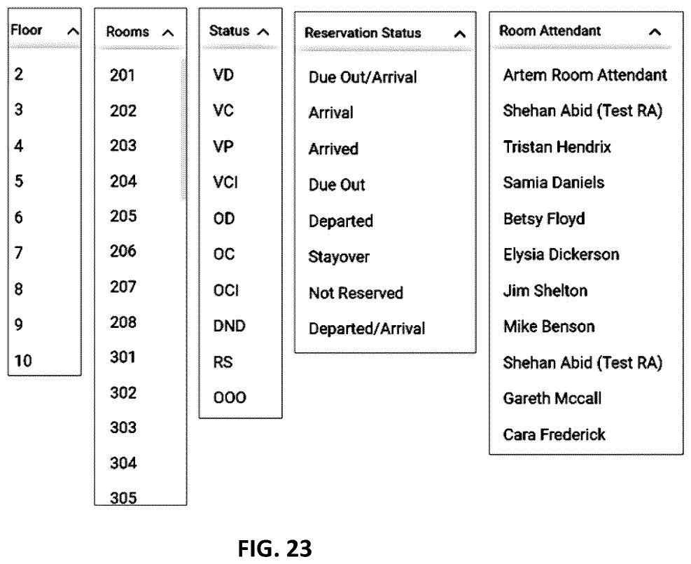

FIG. 24 illustrates an embodiment of the present invention.

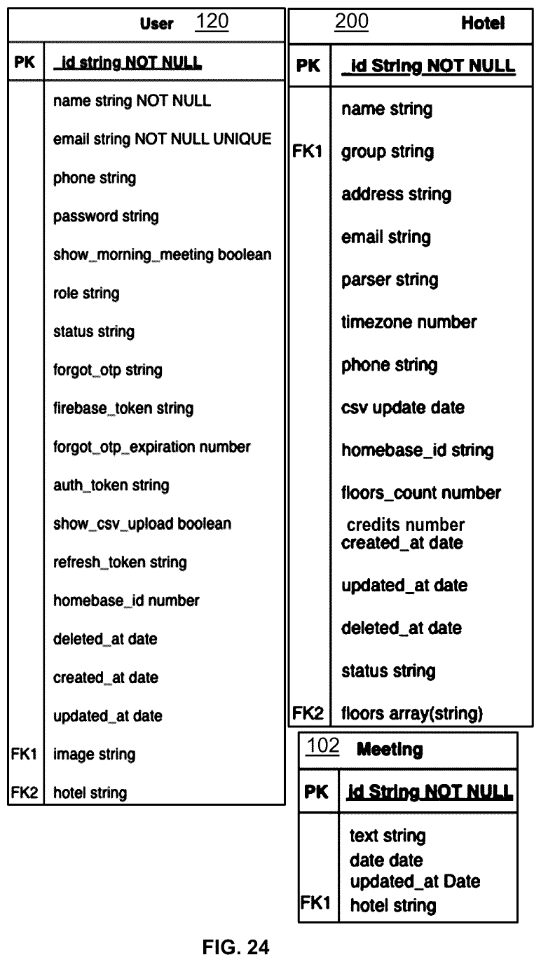

FIG. 24A illustrates an embodiment of the present invention.

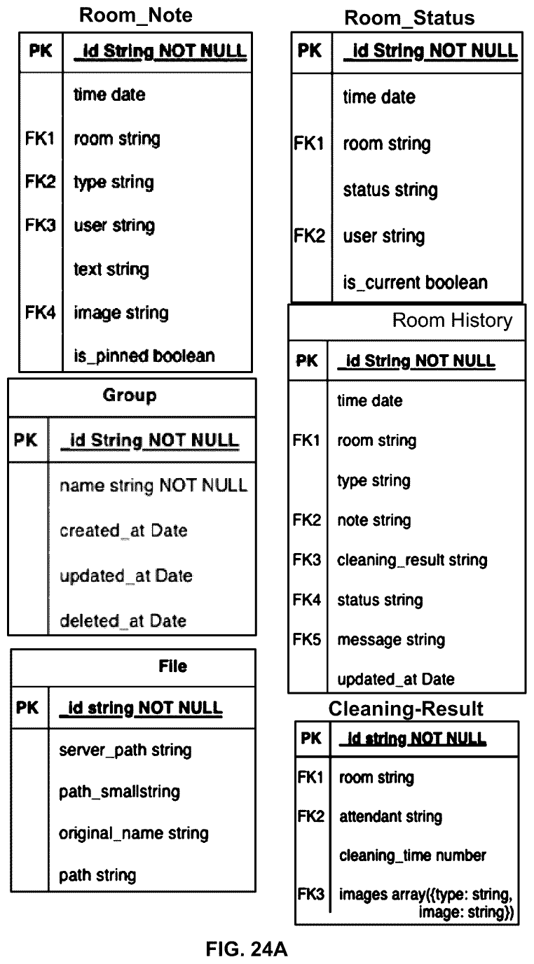

FIG. 25 illustrates an embodiment of the present invention.

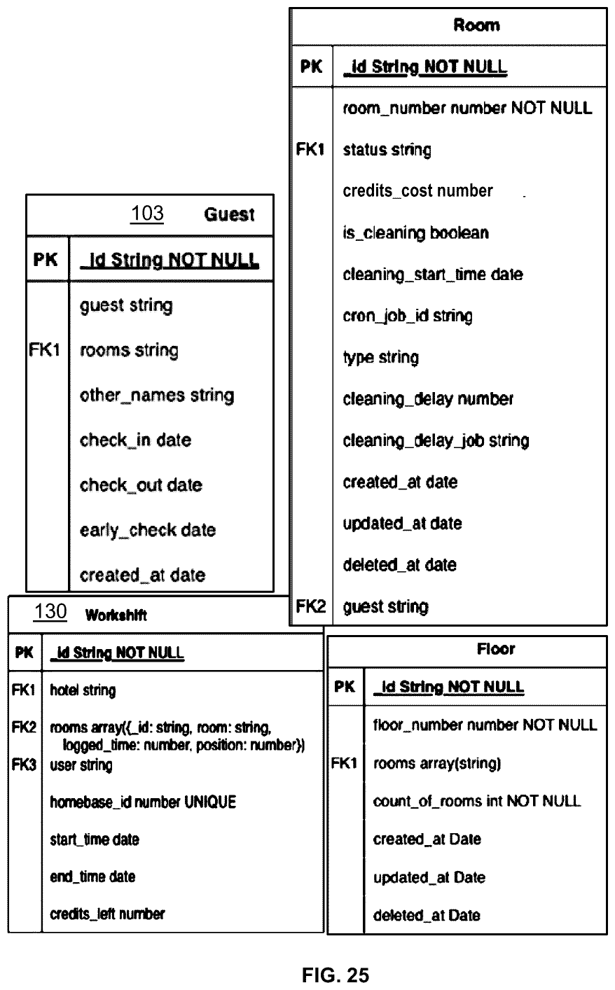

FIG. 26 illustrates an embodiment of the present invention.

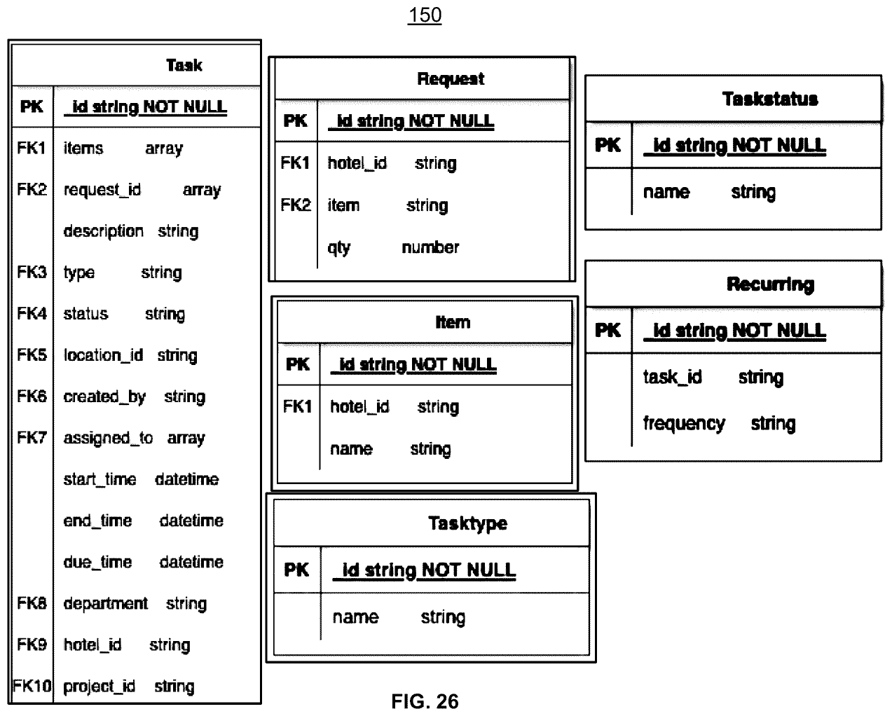

FIG. 27 illustrates an embodiment of the present invention.

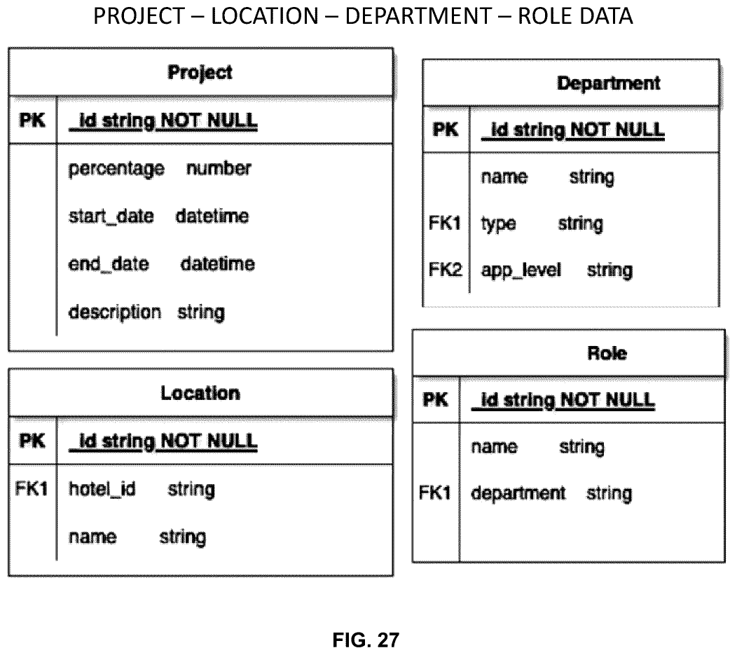

FIG. 28 illustrates an embodiment of the present invention.

FIG. 29 illustrates an embodiment of the present invention.

For clarity all reference numerals may not be included in every figure.

### DETAILED DESCRIPTION OF THE INVENTION

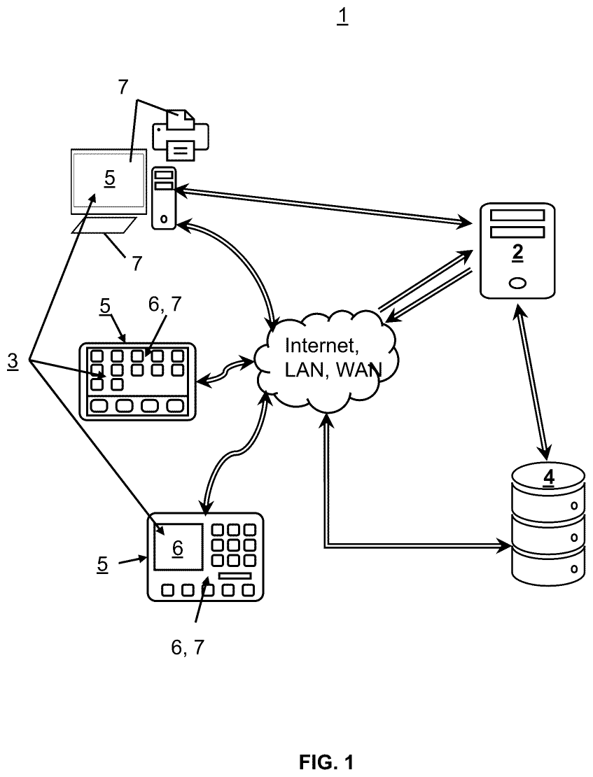

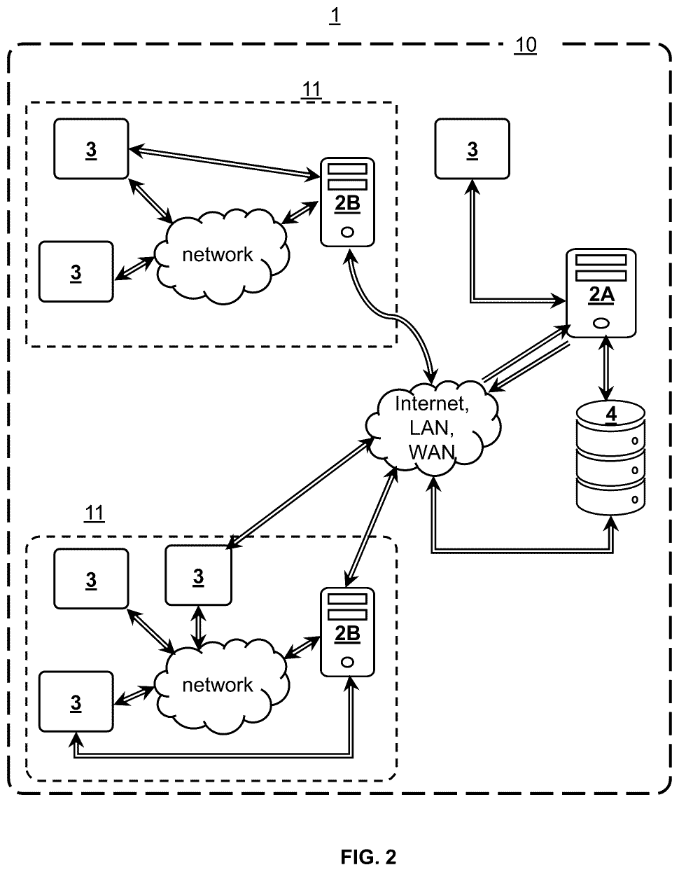

As illustrated in FIGS. 1, 2 embodiments of system 1 may comprise computing system 2 and user interface 3 in wired and/or wireless data communication with each other (over, e.g., a direct connection, LAN, WAN, the Internet). Computing system 2 and user interface 3 preferably are in data communication with a datastore 4. Data communications are illustrated by double-line arrows in FIGS. 1 and 2. Computing system 2 may be associated with a group of hotels 10 (indicated by a long-dash line) or a hotel 11 (indicated by a dash line). In another embodiment of system 1, computing system 2 may be comprised of group computing system 2A and hotel computing system 2B in data communication with user interface 3. Computing system 2A may be associated with hotel group 10 and hotel computing system 2B may be associated with hotel 11.

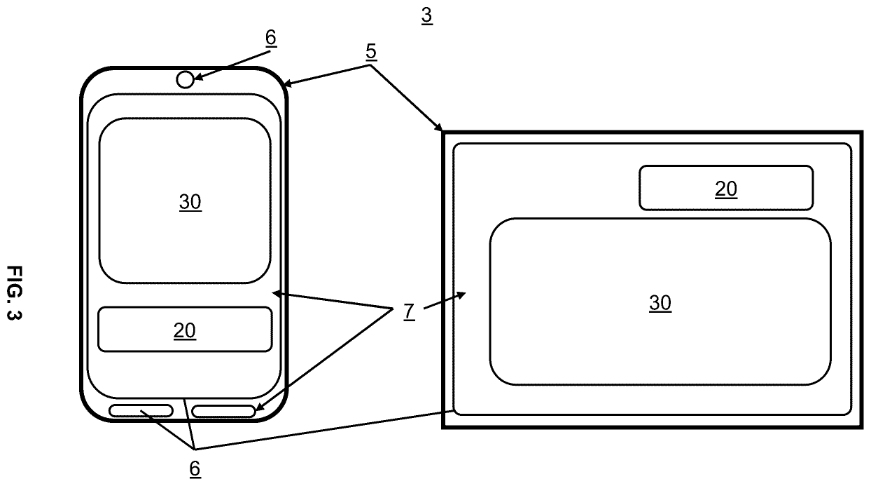

FIG. 3 illustrates embodiments of user interface 3 configured to operate on user device 5 having input device 6 and output device 7. User device 5 may be any device, such as a computer, a mobile device, a wearable, and other user devices 5 capable of outputting information to a user, receiving input from a user, and communicating with computing system 2. User device 5 and computing system 2 are in data communication and may be located adjacent to each other, or may be in distant locations, for example with a computing system located in one or more server facilities, and one or more client devices 5 located in a user's office or carried by a user. Input device 6 may be a touchscreen, keyboard, microphone, camera, input data port, radio receiver, and other devices capable of receiving information external to user device 5. Output device 7 may be a display, speaker, printer, output data port, and other devices capable of transmitting information externally to user device 5.

Datastore 4 stores data records/datasets 100 about one or more hotels 10 which may belong to a hotel group 11 (e.g., a hotel chain, commonly managed hotels). As illustrated in the Figures, Dataset 100 may comprise one or more of a hotel group dataset 101, a hotel dataset 200, a meeting 102 (e.g., morning meeting), guest dataset 103 (hotel or hotel group guest), user dataset 120 (hotel or hotel group, e.g., employee, contractor), workshift dataset 130, and tasks dataset 150. Hotel group dataset 101 may comprise a group_Id, and a group-name. Hotel dataset 200 may comprise a hotel-Id, hotel-name, a group association, hotel-contact-information (address, email, phone), homebase-id, workshift_credits (e.g., “credits”), a floor-count, and a plurality of floors. Workshift_credits may be a representation of the amount of work (e.g., quantity of rooms) that a user may be expected to complete during a workshift. For example, workshift credits for an attendant user may be cleaning_workshift_credits or turndown_workshift_credits representative of the quantity of rooms that the attendant user is expected to clean or turndown in a workshift.

Workshift dataset 130, or simply workshift 130, associated with a user may represent a daily work shift of the user. In a preferred embodiment, workshift 13 comprises a hotel association, a workshift-user, an allocated-rooms set, and the remaining_credits (e.g., “credits_left”) of the workshift-user. Workshift 13 may also comprise a shift start time and shift end time. The allocated-rooms set comprises one or more rooms allocated to the workshift user, and each of the allocated rooms may comprise an allocated room_id, a logged time, and a position (e.g., position in the workshift-user's daily list. Each floor record in the plurality of floors may comprise an Id, a floor-number, a rooms-group a floor-room-count. A room may comprise an Id, a room-number, a room-status, a room credits_cost, an is-cleaning-indicator, a cleaning-start-time, a cron-job-id, a type, a cleaning-delay, a cleaning-delay-job, a room-guest. A room may also be associated with a room history. First-Room-history may comprise an Id, a time, a room, a type, a room-note, a cleaning-result, a status, a message, an updated-at-Date. Second-Room-history may comprise an Id, a time, a room, and a message.

Room credits_cost is representative of the amount of work needed to service a room, and may vary with room characteristics, such as size, amenities, status, location, number of occupants, and various others. Room credit_cost may also comprise a room cleaning_cost and room turndown_cost. Room-note may comprise an Id, a time, a room, a Room-type, a user, a text, an image, and a is-pinned-indicator. Room-status may comprise an Id, a time, a room, a status, a user, and a is-current-indicator.

Location may comprise a Location-Id, a hotel-id, and a location-name. Department may comprise a Department-Id, a name, a type, and an app-level. Meeting may comprise an Id, meeting-text, a date, an updated-at-Date, and a hotel.

Cleaning-result may comprise an Id, a room, a user (e.g., an attendant user), a cleaning-time, and an image having a type. The image type may be an indication of what the image depicts, where it was taken, and other characteristics (e.g., “Bed,” “Bathroom,” “Photo,” “Photo_2,” “Other,” “Other_2,” “Shower,” “Shower_2,” “Toilet,” “Sink,” “Desk”).

Guest may comprise an Id, a guest, guest-rooms, other-guest-names, a check-in-Date, a checkout-Date, and an early-check-Date.

User may comprise a User-Id, a name, an email, a phone, a password, a show-morning-meeting-indicator, a role, a status, a homebase-id, an image, a hotel, and a role (having an Id, a name, and a department). The role may be indicative of a user's job functions, such as an attendant, houseman, engineer, manager, and various others.

Task 151 may comprise an Id, an item, a Request-Id, a description, a Location (e.g., room, floor, common area, hotel, etc.), a created-by-user, an assigned-to-user, a start-time, an end-time, a due-time, a department, a hotel-id, a project-id, a Task-status (having an Id and a name), a Task-type (having an Id, and a name), and a Recurrence (having an Id, a task-id, and a frequency). Item may comprise an Item-Id, a hotel-id, and a name.

A Request may comprise a Request-Id, a hotel-id, an item, and a quantity. A Project may comprise a project-id, a percentage-complete, a start-date, an end-date, a description. Requests may be associated with a category and with a user role, as exemplified in the following Table 1:

TABLE 1
Request Configuration Examples

| | | |
|---|---|---|
| Housekeeping Manager | Vacuum | LIGHTING |
| SUPERVISION | Mop | Entry ceiling light |
| Room rush | Sweep | Bathroom ceiling light |
| Inspect room | Remove garbage | Bathroom mirror light |
| Guest request service | Strip room | Bedside light |
| Check departure | Deep clean | Desk lamp |
| Houseman | Shower curtain | Standing lamp |
| LINEN | King duvet cover | Closet light |
| Bath towel | Queen duvet cover | Hallway light |
| Hand towel | Double duvet cover | FURNITURE |
| Wash cloth | Change bedskirt | Desk touch-up |
| Bath mat | King bed skirt | Vanity touch-up |
| Bath rug | Queen bed skirt | Night stand touch-up |
| Sheet Set | Double bed skirt | Chair broken |
| Pillowcase | King mattress pad | Desk broken |
| Pillow | Queen mattress pad | Bed broken |
| Duvet | Double mattress pad | Night stand broken |
| Duvet Cover | Mattress encasements | PLUMBING |
| Blanket | King duvet insert | Sink clogged |
| AMENITIES | Queen duvet insert | Toilet clogged |
| Shampoo | Pillow protector | Shower clogged |
| Conditioner | Engineering Manager | Bathtub clogged |
| Body wash | CATEGORY | No hot/cold water |
| Bar soap | Requests | Leak |
| Toothbrush | Engineer | ELECTRICAL |
| Toothpaste | PAINT/WALLPAPER | Outlet not working |
| Shower cap | Bathroom touch-up | Lights not working |
| Vanity kit | Ceiling Paint touch-up | The thermostat not |
| Razor | Wallpaper repair | working |
| Shaving Kit | Wood touch-up | TV not working |
| Body Lotion | REPAIRS | The fridge not working |
| Slippers | Door not closing | HVAC too hot |
| Robe | Door not opening | HVAC too cold |
| Deodorant | Latch is missing | phone not working |
| Female Hanger | Window not closing | Clock not working |
| Male Hanger | Window not opening | Outlet Cover Damaged |
| Silk Hanger | Shades repair | Stewarding Manager |
| Water | Curtain repair | CATEGORY |
| Iron & board | Curtain rod missing | Requests |
| Steamer | Door handle loose | Steward |
| CLEANING/BOH | Towel Bar Loose | CATEGORY |
| lonizer | Bathroom Hook Loose | Requests |
| Carpet stain | Bathroom Door not | |
| Shampoo carpet | closing | |

User interface 3 may provide a plurality of interactive panels and controls. User interface 3 may also be configured to detect whether it is displayed on an attendant or manager user device—e.g., by log-in, or be a mobile device. As illustrated in the Figures, a navigation control 20 may be configured to cause UI 3 to switch to one of the interactive panels, comprising a Dashboard, a Rooms UI, an Attendant Allocations UI, Tasks UI, Projects UI, and Daily Checklists & SOP.

FIG. 3 illustrates and embodiment of the UI 3 displaying dashboard with panels, including a Morning Meeting panel, Room Cleaning panel, Tasks panel, Attendants panel, and others. By switching to the morning meeting, a Housekeeping Manager can open the house, and type out the morning meeting messages/notice, instructions, tasks, and other text. The morning meeting information is accessible by staff when they arrive.

On an attendant user device, morning meeting notes from a housekeeping manager are displayed once an attendant user is logged in (accessible to RA at any time during the day). The Room panel lists rooms in order from start to finish with room status, check in/out time, and Indicator if early check in. The room panel allows viewing of room details with room notes, as well as history of room cleaning notes from past days if necessary.

The Figures illustrate the Rooms interactive panel (Rooms UI) as it is viewed on a manager user device and an attendant user device. It enables the viewing of room specifications and to add specific notes for rooms (e.g., VIP, specific guest requests for staff to see). The Rooms UI visualizes various room characteristics by color coding the rooms based on status with check in/out time listed. Room panel also allows a preferred service time to be entered for example when guests request preferred times for their rooms to be serviced. Rooms UI in Attendant View (Attendant Rooms View) display an allocated rooms list comprising rooms that have been allocated to an attendant-user.

The Figures illustrate an allocations Interactive panel which is configured to display the rooms according to status, tasks and other criteria. Room attendants are also displayed according to workshifts. The allocations panel provides an auto allocations control, which when activated, invokes an auto-allocation algorithm to allocate room servicing (e.g., cleaning, turndown) to available attendants (according to attendant's workshift) based on one or more of attendant remaining_credits/credits_left, hotel credits, attendant work load, past performance, types of room serviced, room status, and other factors. Rooms allocated to a workshift-user may be displayed in an allocated rooms list in the Attendant View of the Rooms UI. The allocated rooms list may be sorted according to different criteria to optimize efficiency (e.g., rooms at the top of the list are available for service, have an incoming guest, guest has requested service at a specific time, and other factors). For example, the allocated rooms list may be sorted according to room allocation status, that may be for example ‘departed/arrival’, ‘arrival’, ‘departed’, ‘arrived/departed’, ‘due-out/arrival’, ‘due-out’, ‘not-reserved’, ‘stayover_with_time_request’ (guest staying over has requested a time for service), and ‘stayover’. If room allocation status or other criteria change the allocated rooms list may be re-sorted and the new order may be displayed in the appropriate interactive panel in real time.

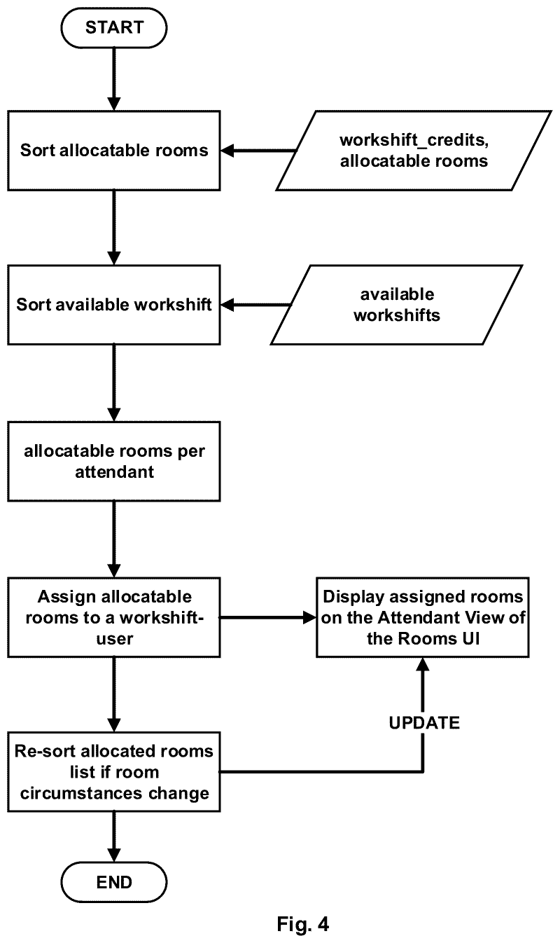

The allocation algorithm may perform several steps, exemplified in the embodiment of FIG. 4. In step 401, the algorithm receives workshift_credits for a hotel, and the allocatable rooms that need cleaning or turndown service (e.g., dirty rooms for cleaning, rooms with guest staying over for turndown) during a time period (e.g., a day), excluding out of order rooms. The allocatable rooms may be sorted by room number or other criteria (e.g., sorting rooms based on proximity to each other). In step 402, the algorithm receives available workshifts for a time period (e.g., workshift-users working during a day) in the hotel where the workshift-user has a role as a room attendant. The available workshifts may be sorted by workshift-user according to various criteria, including manual sorting provided by a manager. In step 403, the algorithm may then determine the quantity of allocatable rooms per attendant based on the quantity of allocatable rooms and the quantity of available workshifts. In step 404, the algorithm then assigns allocatable rooms to a workshift-user according to remaining_credits, workshift_credits, and room credits_cost. When a workshift-user has already been assigned allocatable rooms whose combined room credits_cost satisfies the workshift_credits for the hotel (e.g., the remaining credits is zero or less than the smallest room credits_cost), the subsequent allocatable room are assigned to the next workshift-user in the available workshift until that workshift-user's workshift credits are satisfied, and so on. In step 405, the workshift assigned rooms are then displayed as an allocated rooms list on the Attendant View of the Rooms UI. In step 405, as previously explained, the allocated rooms checklist may be re-sorted if rooms circumstances change, and the re-sorted allocated rooms list is updated in real time on the Attendant View of the Rooms UI.

In another embodiment, the allocation algorithm determines which rooms should be cleaned and by whom, based on the workshifts of hotel staff and a specified allocation type, which defaults to cleaning but can be other types. This system optimizes room allocation in a hotel setting, ensuring efficient use of resources and maximizing productivity. The allocation algorithm comprises a Prepare Allocation module that gathers necessary information, including details about the hotel, user workshifts, and the type of room allocation. If there are active user workshifts, the Prepare Allocation module filters out rooms based on the hotel's workshifts and the allocation type, and rooms exempted from future workshifts. If any rooms are left after the filtering out and if there are active workshifts exist, the Prepare Allocation module calculates the average count of rooms per attendant and filters out rooms that are already allocated. The Prepare Allocation module returns an allocation preparation object containing the rooms, active workshifts, future workshifts, average count, and cleaning or turndown credit per room attendant.

The allocation algorithm further comprises an Auto Allocation module to automate room allocation based on the allocation preparation object. The Auto Allocation module sorts workshifts and filters room attendants and calculates the average number of rooms per attendant and prepares a list of room IDs for assignment. Allocatable rooms are assigned to attendants in a repeating loop until all rooms are assigned. The Auto Allocation module defines an order for room statuses and sorts the assigned rooms for each attendant based on this order. A final auto allocation object mapping each room attendant's ID to their assigned rooms is prepared.

The allocation algorithm may also determine whether the room allocation is intended for an attendant device (usually a mobile device) or for a manager device and may be configured to provide different types or amount of room allocation information.

The Figures illustrate the tasks interactive panel having an active tasks view, a completed tasks view, and an upcoming tasks view. Tasks panel also provides user control configured to enable the UI to sort task by department, task type, user to whom a task is assigned (assigned), task location, date, and others. Tasks user controls also are configured to enable a user to display and edit task details. The tasks Interactive panel also may be configured to enable the creation, tracking, and monitoring of requests (e.g., guest requests), houseman/engineering/maintenance tasks, projects and checklists.

The Figures illustrate a projects interactive panel having active projects view, completed projects view, and upcoming projects view. Projects panel also provides user controls configured to enable the UI to sort projects and to enable a user to display and edit projects details.

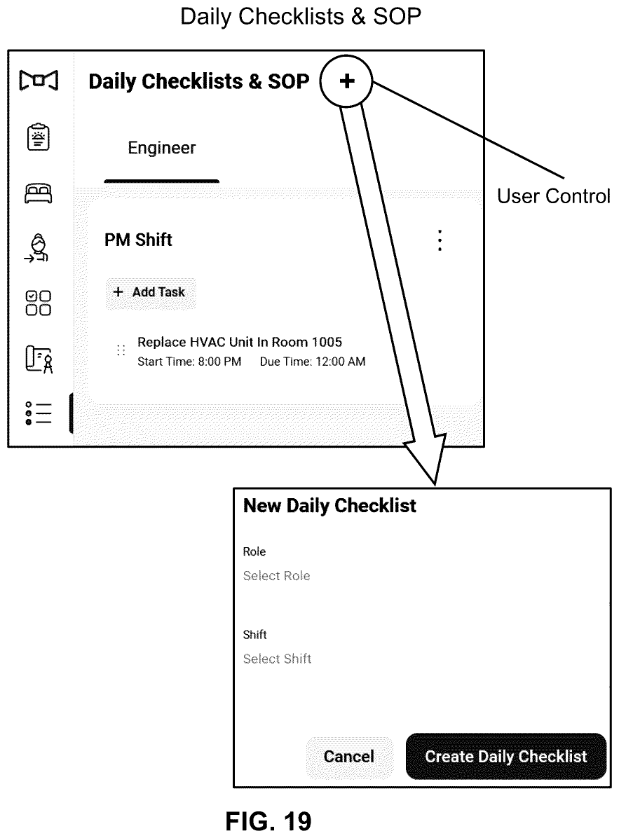

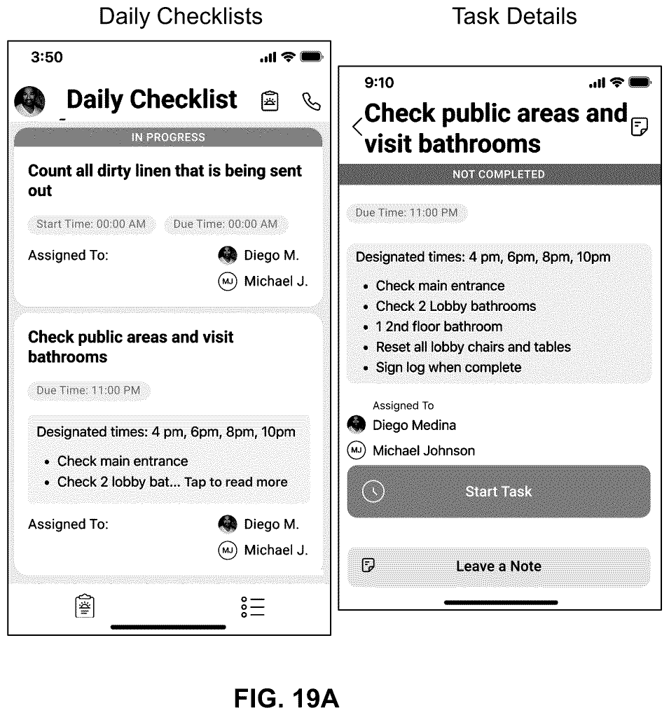

FIGS. 19 and 19A illustrate A Daily Checklists interactive panel displaying the tasks assigned to users (e.g., Diego M. and Michael J.). Daily Checklists panel also provides user controls configured to enable the UI to add new checklists, view task details, “Start task,” or “Leave a Note.” FIG. 19A illustrates a Daily Checklist including tasks (e.g., “Count all dirty linen . . . ,” “Check public areas and visit bathrooms”), due time (e.g., “11 PM”) and the user assigned to the tasks (e.g., Diego M. and Michael J.). The interactive panel further may comprise user controls (e.g., clicking on the tasks) to display Task Details, status (“NOT COMPLETED”), user controls (e.g., “Start Task,” “Leave a Note”), and other task information, as illustrated in the FIG. 19A (e.g., providing details for “Check public areas and visit bathrooms” task, to be performed at 4 pm, 6 pm, 8 pm, and 10 pm and to be completed by 11 PM).

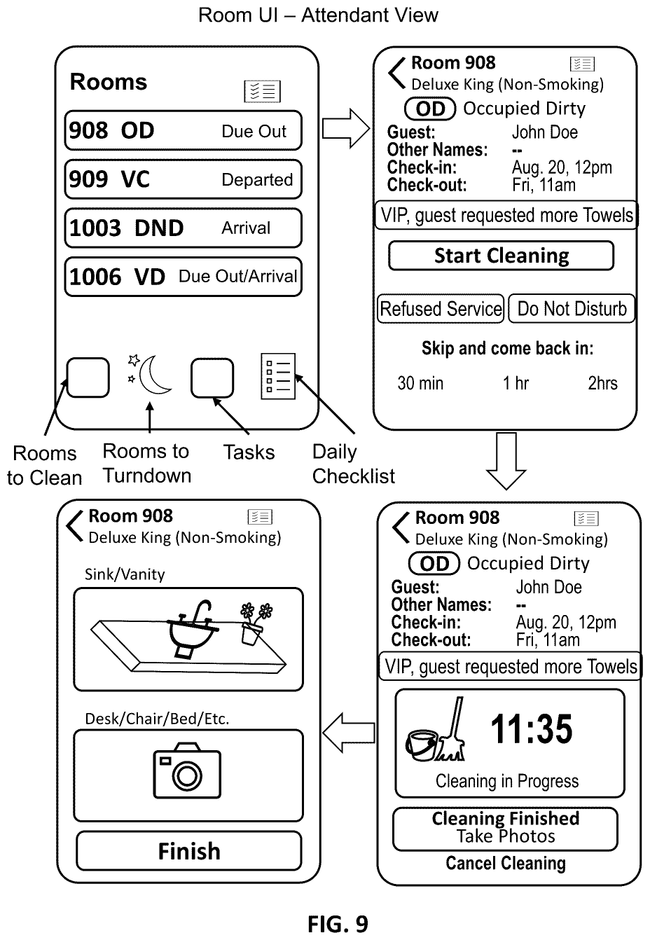

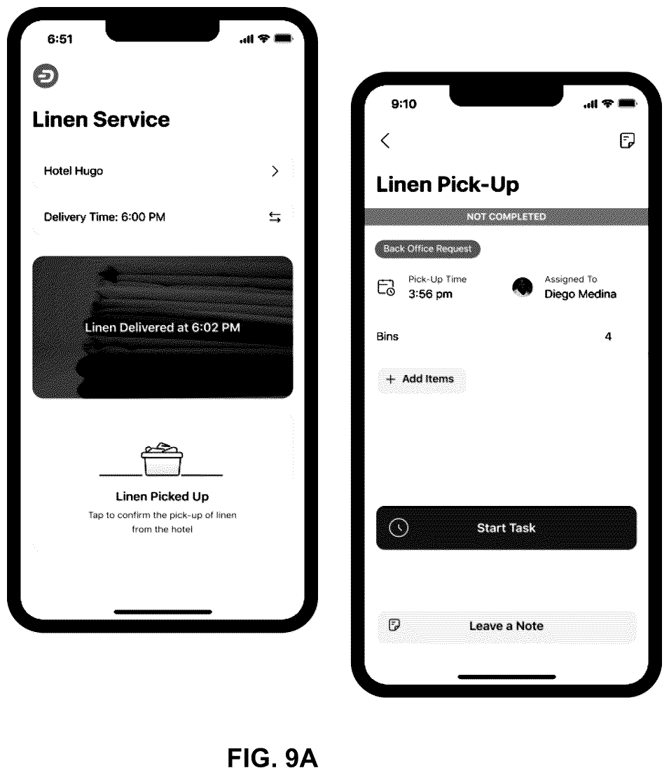

As FIG. 9 illustrates the UI is configured to enable a user, for example a room attendant (RA) who may be an attendant user assigned to the room, to begin cleaning a room by tapping ‘Start Cleaning’ in the room view, which starts a cleaning timer. Upon completion of the cleaning, RA may click finish. RA may take photos with the user device before and after cleaning, and the images become part of the Room View.

When room cleaning has finished, the room's status, images, and other information is available in real time to a housekeeping manager.

In situations where a guest in a dirty room refuses service (RS) or has a Do not Disturb (DND) sign, the RA can utilize user controls to change room status to indicate DND or RS in the room view, and the system is configured to enter a task to clean the room based on a new time.

Inspectors can review initial inspection from the images and notes taken by RA who cleaned the room. Inspectors can also input additional notes, or visit a room in person and take additional pictures and input additional notes.

Embodiments of the present invention allow management of hotel delivery services, like linen, laundry, or flower delivery, to notify hotel staff when the delivery is completed or if it is being delayed, as illustrated in the example of FIG. 9A.

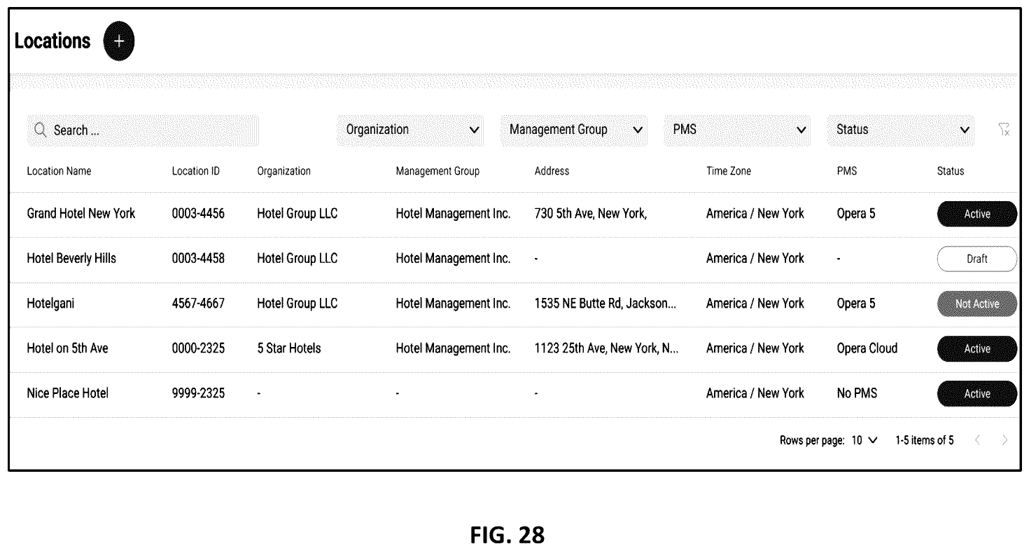

As FIG. 28 illustrates, embodiments of the present invention allow monitoring and oversight of multiple hotels in a hotel group in real time from one platform combining different scheduling systems and PMS systems into one easy to use platform.

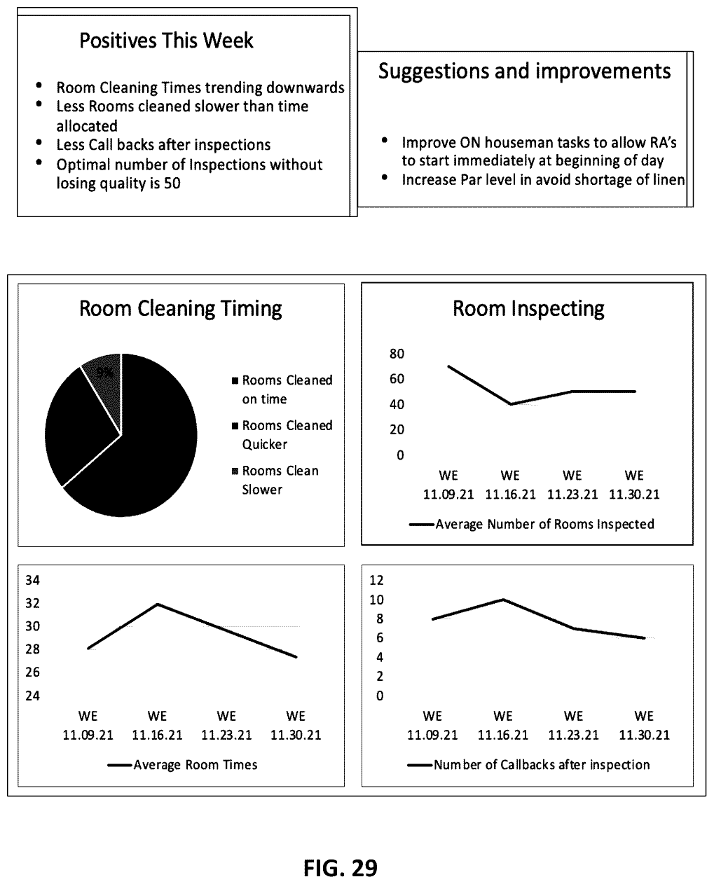

A Reporting module, illustrated in FIG. 29, may provide accurate data of efficiencies across the property to improve cost metric calculations, and may provide data driven suggestions and improvements to save costs and improve operations. Reports can be generated to view one, two or all hotels in a hotel group. Management can also custom reports and create reports for whatever fields they wish to see.

While the invention has been described with reference to exemplary embodiments, it will be understood by those skilled in the art that various changes, omissions, and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiments disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

I claim:

1. A system for managing operations for a plurality of hotel rooms, the system comprising:
a computing system;
a user device selected from an attendant device, a manager device, and combinations thereof;
a GUI;
a datastore storing data related to a hotel, the data comprising a hotel associated with the plurality of hotel rooms and with a floor;
a plurality of rooms, wherein each room of the plurality of rooms comprises room information about a hotel room from the plurality of hotel rooms;
a guest;
a workshift associated with a user; and,
a tasks dataset comprising a project, a task, a request, an item, and a task location;
wherein the hotel comprises a floors count;
wherein the floor is associated with a plurality of floor rooms comprising floor room information about a floor room;
wherein the floor comprises a floor id and a floor rooms count;
wherein the room information comprises a room id, a room number, a room status, room cleaning information, and a room type;
wherein the room status information is selected from the group consisting of a dirty status, a clean status, and an out-of-order status;
wherein the room is associated with a room history, and a room note;
wherein the user comprises a user id and user information;
wherein the user information comprises a user role selected from an attendant and a manager;
wherein the hotel is associated with a morning meeting comprising a meeting-message, and a meeting date;
wherein the room cleaning information comprises a cleaning indicator and a cleaning_result;
wherein the cleaning result comprises a user id, and one or more of a cleaning time, an image, and a cleaning note;
wherein the GUI is configured to:
receive the meeting message from the manager device and display the morning message on the attendant device; and,
display an attendant checklist panel comprising a list of an attendant room and an attendant control associated with the attendant room;
wherein responsive to activating the attendant control, the GUI is configured to:
initiate a room cleaning timer counting the cleaning time; and,
display on the attendant device a room cleaning view comprising a stop cleaning control;
wherein responsive to activating the stop cleaning control the GUI receives the cleaning time from the room cleaning timer;
wherein responsive to activating the stop cleaning control the GUI is configured to receive one or more of the cleaning image, the cleaning note, and a cleaning finished indicator; and,
wherein responsive to receiving the cleaning finished indicator the GUI is configured to change the room status to the clean status.
